(19) United States
(12) Patent Application Publication
(10) Pub. No.: US 2021/0075239 A1
(43) Pub. Date: Mar. 11, 2021

(54) FLOOR-STANDING ENERGY DISPENSER, AND SYSTEM COMPRISING AN ENERGY DISPENSER AND A SUPPLY MECHANISM

(71) Applicants: Carola ZWICK, Berlin (DE); Roland ZWICK, Berlin (DE); Burkhard SCHMITZ, Berlin (DE)

(72) Inventors: Carola ZWICK, Berlin (DE); Roland ZWICK, Berlin (DE); Burkhard SCHMITZ, Berlin (DE)

(21) Appl. No.: 17/072,326

(22) Filed: Oct. 16, 2020

Related U.S. Application Data
(63) Continuation of application No. PCT/EP2019/059931, filed on Apr. 17, 2019.

(30) Foreign Application Priority Data
Apr. 17, 2018 (DE) 10 2018 109 089.7

(51) Int. Cl. H02J 7/00; H01R 33/20; H01R 31/06

(52) U.S. Cl. CPC H02J 7/0045; H01R 31/02; H01R 31/065; H01R 33/20

(57) ABSTRACT

An energy dispenser comprising a base plate, a casing having a funnel inlet and a funnel outlet, a neck having a tube inlet and a tube outlet, a head, a charging socket outlet, a cable assembly and an energy storage device for electrical energy. The funnel inlet is connected to the base plate, the funnel outlet transitions into the inlet of the neck, and the outlet of the neck transitions into the head. The charging socket outlet is arranged in the head and is connected to a first end of the cable assembly. The cable assembly is routed out of the head, through an interior of the neck, into a cavity of the casing. The energy storage device is in the cavity of the casing, and a second end of the cable assembly is connected to the energy storage device.

### CROSS REFERENCE TO RELATED APPLICATIONS

This application is a continuation of International Application No. PCT/EP2019/059931 filed Apr. 17, 2019, which designated the United States, and claims the benefit under 35 USC § 119(a)-(d) of German Application No. 10 2018 109 089.7 filed Apr. 17, 2018, the entireties of which are incorporated herein by reference.

### FIELD OF THE INVENTION

The present invention relates to a floor-standing energy dispenser, a system that comprises an energy dispenser, and a supply mechanism.

### BACKGROUND OF THE INVENTION

Known from EP 2 929 808 A1 is at item of furniture, realized as a table, on or in which a storage module, for storing electrical energy and for delivering the stored electrical energy to an electrical device that can be arranged on the item of furniture, can be arranged.

### SUMMARY OF THE INVENTION

The present invention is based on the object of developing a floor-standing energy dispenser, a system comprising an energy dispenser, and a supply mechanism, that is easily assembled, stable and, in particular, tension-stable, and, therefore, suitable for being carried by hand.

The floor-standing energy dispenser according to the present invention comprises a base plate, a funnel-type casing having a funnel inlet and a funnel outlet, a tubular neck having a tube inlet and a tube outlet, a head, at least one charging socket outlet, a cable assembly and an energy storage device for electrical energy, the casing being connected by means of its funnel inlet to the base plate, the casing transitioning by means of its funnel outlet into the inlet of the neck, and the neck transitioning by means of its outlet into the head, the at least cone charging socket outlet being arranged in the head, the at least one charging socket outlet being connected to a first end of the cable assembly, the cable assembly being routed out of the head, through an interior of the neck, into a cavity of the casing, the energy storage device being arranged in the cavity of the casing, and a second end of the cable assembly being connected to the energy storage device. As a result of the components being constructed in a layered manner, such an energy storage device is easily assembled, and is stable because of the low arrangement of the energy storage device.

It is also provided to realize the energy storage device as a ring-type body having a feed-through opening. As a result, the latter has the same stability on all sides.

It is also provided that the energy dispenser additionally comprises a connection mechanism, the head being connected to the base plate, through the neck and the casing, by the connection mechanism, the connection mechanism being connected as a rigid connection mechanism, in particular, as a rod, and preferably, as a threaded rod, or as a flexible connection mechanism, in particular, as a cord or a band. In this way, when the energy dispenser is being carried at the head that forms a grip element, neither the neck nor the casing has to transmit a tensile force resulting from the weight of the energy storage device. The energy dispenser thus has a high tensile stability and, despite a light and technically simple structure of the neck and casing, comparatively heavy, and thus powerful, energy dispensers can also be constructed, without the structural design of the energy dispenser having to be altered as a result.

It is additionally provided that the feed-through opening of the energy storage device is aligned centrally in relation to the base plate, and the energy storage device is supported, in particular, flatly, on an upper side of the base plate, and the feed-through opening has the connection mechanism extending through it. It is, thereby, possible to realize an energy storage device that is stable and equally tilt-proof on all sides.

It is also provided that the base plate has a diameter that corresponds to at least 3 times, and preferably at least 4 times, a diameter of the neck, in particular, in the region of the tube inlet. The energy storage device thereby has a comparatively large support surface, and is slender towards the head region, such that the latter can be moved close to tabletops.

It is also provided that the energy dispenser comprises at least one platform, the platform being arranged between the casing and the head, and, in particular, being arranged between the casing and the neck. This creates a deposit surface that enables the energy dispenser to be used, without further items of furniture, for depositing devices to be charged.

It is also proposed that the platform comprises at least one transmission mechanism for wirelessly transmitting energy, the transmission mechanism being realized in such a manner that a mobile device, lying on the platform, that comprises a suitable receiving mechanism can be charged, the at least one transmission mechanism being connected to the energy storage device via the cable assembly. The charging of mobile devices is thereby rendered particularly simple, and as a result the energy dispenser is also suitable, in particular, for brief charging of mobile devices.

It is additionally provided that the at least one charging socket outlet is arranged in the head in such a manner that, when the energy dispenser is upright, a connector of a device to be connected can be connected in the horizontal direction to the charging socket outlet and can be separated in the horizontal direction from the charging socket outlet. Plugging-in and unplugging, and identification of the design of the respective charging socket outlet, are thereby rendered particularly simple, since the contact surfaces of the charging socket outlet are easily visible to a user from a seated position.

It is also provided that the energy dispenser comprises a charging device, via which the energy storage device can be supplied and charged with electric current, the charging device being realized in such a manner that it can be supplied with electric current by means of a receiving mechanism that can be supplied wirelessly, and/or in a wired manner, by means of a mating connector. The energy dispenser can thereby be technically equipped in such a manner that it can be operated without conversion on 220V electricity supply systems and 110V electricity supply systems, and inductively supplied power outputs can be optimally forwarded to the energy storage device.

Additionally, it is also provided that the energy dispenser comprises a set of power electronics, the set of power electronics comprising, in particular, a voltage transformer and an inverter, the set of power electronics being connected, in particular, to the cable assembly, and being arranged, in particular, between the energy storage device and the at least one charging socket outlet, or being arranged, in particular, between the energy storage device and the at least one charging socket outlet and the platform. A corresponding set of power electronics enables mobile devices of differing voltage and power to be supplied at the energy dispenser.

Finally, it is also provided that the energy dispenser comprises at least one light source fed from the energy storage device, the light source being arranged, in particular, as a flat lamp, on a surface of the energy dispenser that is opposite the base plate, in particular, on an underside of a platform, or being arranged on a surface of the energy dispenser that faces away from the base plate, in particular, on an upper side of a platform, or the light source being arranged, in particular, as a punctiform or flat lamp, on an extension of the head or on an extension of the neck. Additional provision of illumination mechanisms are rendered superfluous by such energy dispensers.

The system according to the present invention comprises an energy dispenser and a supply mechanism, the energy storage device being realized as a floor-standing energy dispenser according to present invention, and a wired and/or wireless supply of energy for the energy dispenser being able to be provided by the supply mechanism, when the energy dispenser is placed with its base plate onto a contact plate of the supply mechanism. Such a system is easily assembled, owing to the components of the energy dispenser being built up in a layered manner, and is stable because of the low arrangement of the energy storage device, both on a base and on the supply mechanism.

It is also provided that the supply mechanism receives the base plate of the energy dispenser or the base plate and the casing of the energy dispenser by positive engagement. The stability of the energy dispenser is thereby further improved. In addition, reliable transmission of energy, from the base plate to the energy dispenser, is thereby ensured.

It is additionally provided that, for the purpose of wirelessly transmitting energy, the supply mechanism comprises a transmission mechanism, and the energy dispenser comprises a receiving mechanism, the transmission mechanism being arranged, in particular, in the region of the contact plate of the supply mechanism, and the receiving mechanism being arranged, in particular, in the region of the base plate of the energy dispenser. Consequently, it is sufficient for a user to place the energy dispenser on the base plate in order to charge its energy storage device.

Finally, the system provides that, for the purpose of wirelessly transmitting energy, the supply mechanism comprises a connector, and the energy dispenser comprises a mating connector, the connector being arranged, in particular, in the region of the contact plate of the supply mechanism, and, in particular, centrally on an upper side of the contact plate, the mating connector being arranged, in particular, in the region of the base plate of the energy dispenser, and, in particular, centrally on an underside of the contact plate, the connector and the mating connector being realized, in particular, as coaxial connectors, and preferably being realized as coaxial connectors designed for the transmission of alternating current. In the case of such as design, also, it is sufficient for a user to place the energy dispenser on the base plate in order to charge its energy storage device.

### BRIEF DESCRIPTION OF THE DRAWINGS

Further details of the present invention are described in the drawing on the basis of schematically represented exemplary embodiments.

FIG. 1a shows a perspective view of a first embodiment variant of a floor-standing energy dispenser according to the present invention;

FIG. 1b shows a perspective view of a first embodiment variant of a supply mechanism for the energy dispenser shown in FIG. 1a;

FIG. 2 shows a second embodiment variant of a floor-standing energy dispenser according to the present invention;

FIG. 3 shows a third embodiment variant of a floor-standing energy dispenser according to the present invention;

FIG. 4 shows a sectional representation of the energy dispenser shown in FIG. 1a;

FIG. 5 shows a sectional representation of a fourth embodiment variant of a floor-standing energy dispenser according to the present invention;

FIGS. 6 and 7 show two sectional representations of a fifth embodiment variant of a floor-standing energy dispenser, including a sectional representation of an associated supply mechanism; and

FIGS. 8a-8e show five variants of a sixth embodiment variant of a floor-standing energy dispenser.

### DETAILED DESCRIPTION OF THE INVENTION

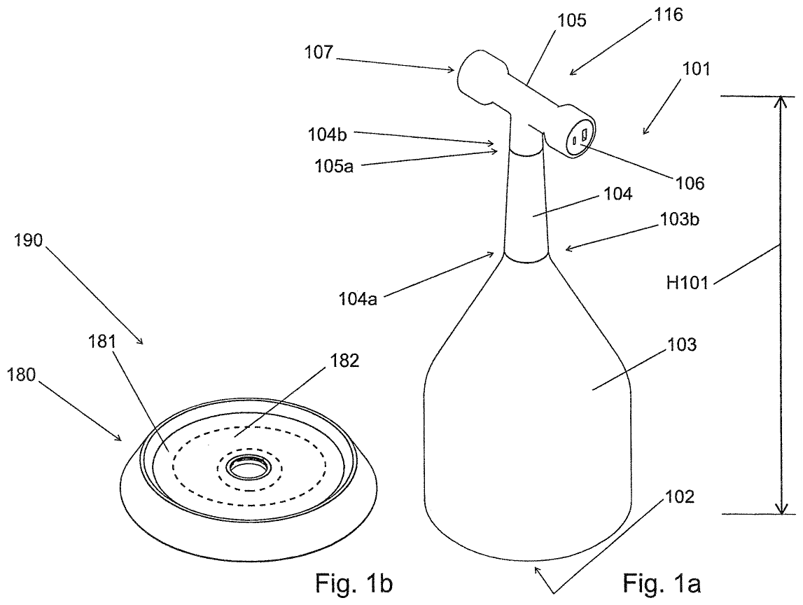

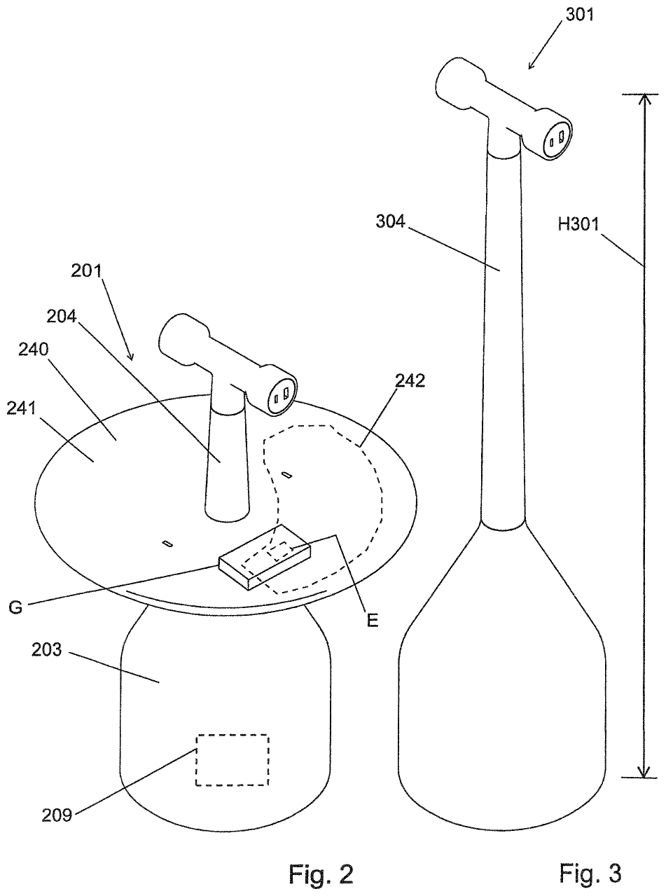

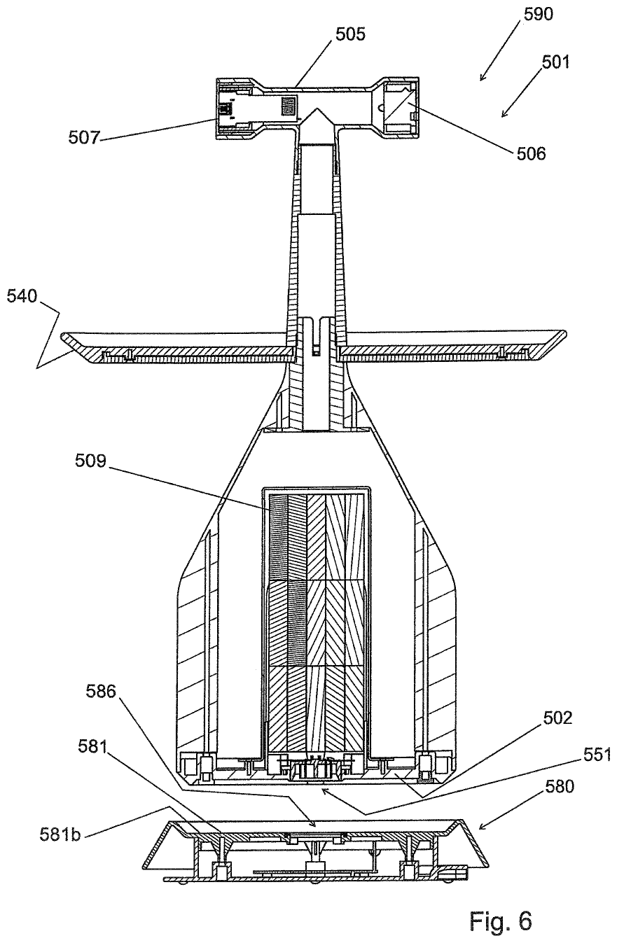

Shown in FIG. 1a, in a perspective view, is a first embodiment variant of a floor-standing energy dispenser 101 according to the present invention. This energy dispenser 101 is additionally represented, in a partially schematic sectional view, in FIG. 4. The energy dispenser 101 comprises a base plate 102, a funnel-type casing 103 having a funnel inlet 103a and a funnel outlet 103b, a tubular neck 104 having a tube inlet 104a and a tube outlet 104b, a head 105 having a head inlet 105a, a first charging socket outlet 106 and a second charging socket outlet 107, a cable assembly 108, and an energy storage device 109 for storing electrical energy.

In this case the casing 103 is connected, by means of its funnel inlet 103a, to the base plate 102. In addition, the casing 103 transitions, by means of its funnel outlet 103b, into the inlet 104a of the neck 104, and the neck 104 transitions, by means of its outlet 104b, via the head inlet 105a, into the head 105. The charging socket outlets 106, 107 are arranged in the head and connected to first ends 110a, 110b of the cable assembly 108. The cable assembly 108 is routed out of an interior 105c of the head 105, through an interior 104c of the neck 104, into a cavity 103c of the casing 103. There is an energy storage device 109 arranged in the cavity 103c of the casing 103. A second end 111a of the cable assembly 108 is connected to the energy storage device 109. The energy storage device 109 is realized as a ring-type body 112 having a feed-through opening 113.

The energy dispenser 101 additionally comprises a connection mechanism 114. In this case, the head 105 is connected by a connection mechanism, through the neck 104 and the casing 103, to the base plate 102. The connection mechanism 114 is embodied, as a rigid connection mechanism, in the form of a threaded rod 115 that extends through the feed-through opening 113 and that is screw-connected to the head 105 and to the base plate 102. For this purpose, the head 105 comprises a threaded nut 105d, and the base plate 102 comprises a threaded nut 102d. The head 105, the neck 104 and the casing 103 are connected to each other via plug-in connections. According to an embodiment variant that is not represented, it is also provided to realize the connection mechanism as a flexible connection mechanism, and in particular as a cord or as a band. Irrespective of how it is realized, the connection mechanism 114 has the effect of relieving strain on the neck 104 and the casing 103 when the energy dispenser 101 is being carried at the head 105 that forms a grip element 116, since tensile force resulting from the weight of the energy storage device can be transferred via the connection mechanism 114.

The feed-through opening 113 of the energy storage device 109 is aligned centrally in relation to the base plate 102, and the energy storage device 109 is supported flatly on an upper side 102b of the base plate 102, the connection mechanism 114 extending through the feed-through opening 113, and the energy storage device 109 thereby also being held, secured against displacement, in the cavity 103c of the casing 103.

The base plate 102 has a diameter D102 that is at least 3 times, and preferably at least 4 times, a diameter D104a of the neck 104 that the latter has in the region of its tube inlet 104a.

Together with a supply means 180 shown in a perspective view in FIG. 1b, the energy dispenser 101 forms a system 190. Owing to the supply mechanism 180, it is possible for energy to be supplied wirelessly to the energy dispenser 101. For this purpose, the energy dispenser 101 must be placed, by means of its base plate 102, onto a contact plate 181 of the supply mechanism 180. The supply mechanism 180 in this case receives the base plate 102 of the energy dispenser 101, and a lower portion of the casing 103 of the energy dispenser 101, by positive engagement, such that the energy dispenser 101 is centered onto the base plate 102. For wireless transmission of energy, the supply mechanism 180 comprises a transmission mechanism 182 that is integrated into the contact plate (indicated by broken lines), and the energy dispenser 101 comprises a receiving mechanism 117 (indicated schematically) that is integrated into the base plate 102.

The charging socket outlets 106, 107 are arranged in the head 105 in such a manner that, when the energy dispenser 101 is standing on a base U, connectors S106, S107 of devices to be connected, not represented, can be connected to the charging socket outlet 106 or 107 in the horizontal direction x or x′, and can be separated from the charging plug connector 106 or 107 in the horizontal direction x′ or x.

The energy dispenser 101 also comprises a charging device 118. By means of the charging device 118, the energy dispenser 101 can be supplied and charged with electric current, the charging device 118 being realized in such a manner that it can be supplied by the wireless receiving mechanism 117.

The energy dispenser 101 additionally comprises a set of power electronics 119. The set of power electronics 119 comprises a voltage transformer 120 and, optionally, an inverter 121. The set of power electronics 119 is connected to the cable assembly 108, and arranged between the energy storage device 109 and the charging socket outlet 106, 107.

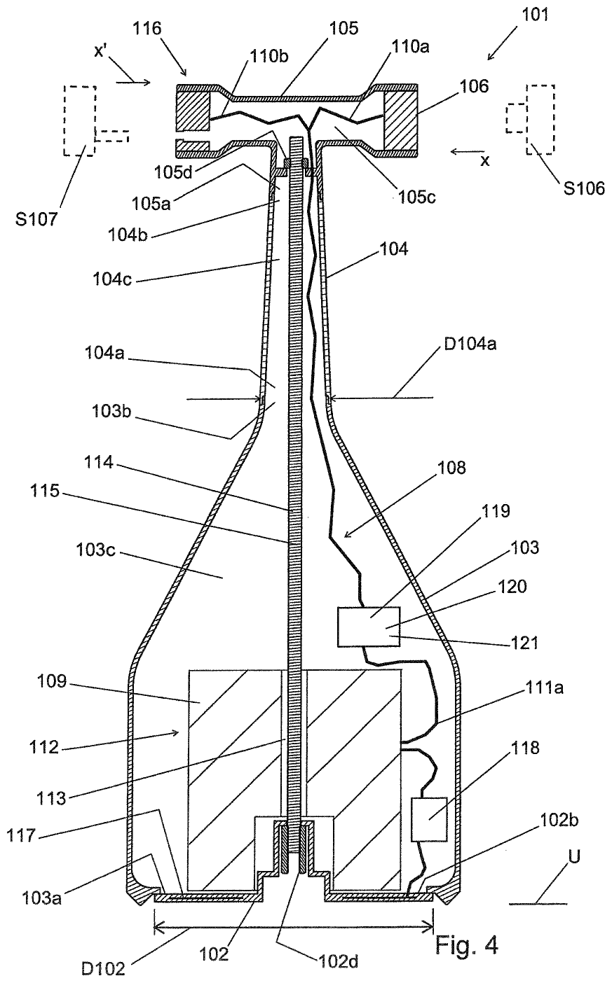

A second embodiment variant of a floor-standing energy dispenser 101 according to the present invention is shown in a perspective view in FIG. 2. This energy dispenser 201 is basically comparable in its embodiment to the energy dispenser 101 shown in FIGS. 1a and 4. To that extent, reference is also made to the description relating to FIGS. 1a and 4. Unlike the latter, the energy dispenser 201 comprises at least one platform 240, the platform 240, which forms a type of tabletop, being arranged between a casing 203 and a neck 204. According to an embodiment variant that is not represented, it is also provided to arrange the platform between the neck and a head, or at any height position on the neck or on the casing. The platform 240 comprises a schematically indicated transmission mechanism 242 for close-range wireless transmission of energy, the transmission means 242 being realized in such a manner that a mobile device G, lying on the platform, that comprises a suitable receiving mechanism E, can be charged, the transmission mechanism 242 being connected to an energy storage device 209 of the energy dispenser 201 via a cable assembly, which is known from the description relating to FIGS. 1a and 4, but which is not visible in the representation of FIG. 2.

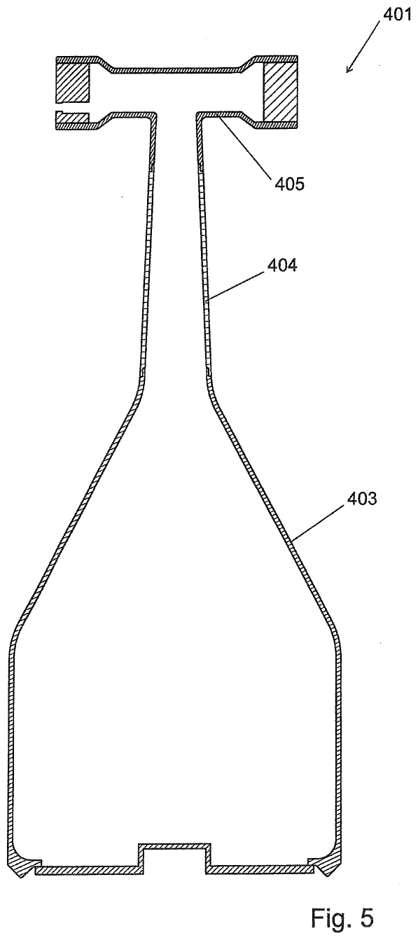

Shown in FIG. 3, in a perspective view, is a third embodiment variant of a floor-standing energy dispenser 301 according to the present invention. This energy dispenser 301 is basically comparable in its embodiment to the energy dispenser 101 shown in FIGS. 1a and 4. To that extent, reference is also made to the description relating to FIGS. 1a and 4. Unlike the latter, in the case of the energy dispenser 301 a neck 304 is made longer, such that the energy dispenser 301, having its height H301, is suitable for being placed next to a desk or dining table, the energy dispenser 101, having its height H101, being intended, for example, for being placed next to an armchair or a sofa.

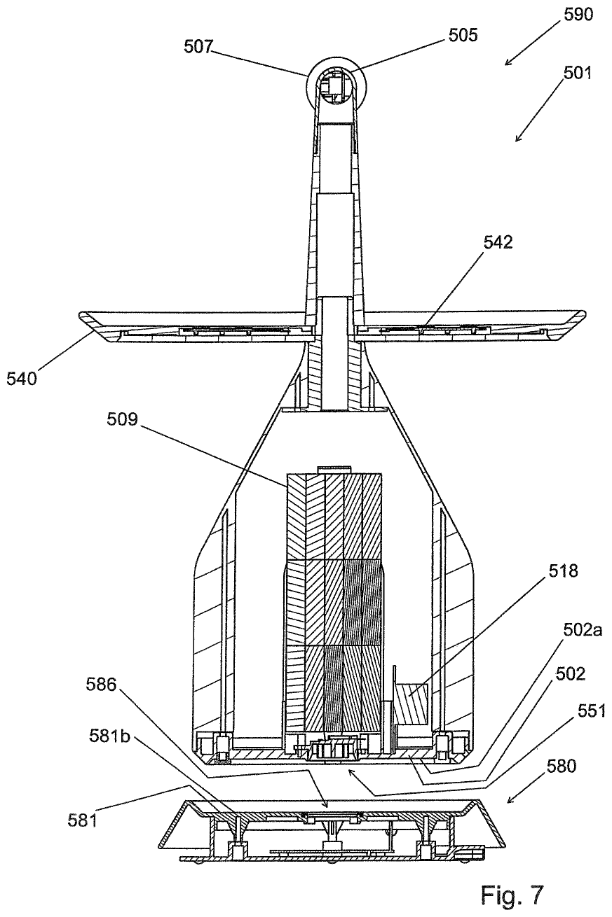

Shown in FIG. 5, in a sectional view, is a fourth embodiment variant of a floor-standing energy dispenser 401 according to the present invention. This energy dispenser 401 is basically comparable in its embodiment to the energy dispenser 101 shown in FIGS. 1a and 4. To that extent, reference is also made to the description relating to FIGS. 1a and 4. Unlike the latter (cf. in particular, FIG. 4), the energy dispenser 401 is realized without a connection mechanism, all other components shown in FIG. 4, such as, for example, an energy storage device and a cable assembly of course being present, and only being masked in the representation of FIG. 5. In the case of the energy dispenser 401, connections between the casing 403 and the neck 404, and between the neck 404 and the head 405, are realized as tension-resistant connections and, for example, as bonded plug-in connections or as screwed connections.

Together with the supply mechanism 180, the energy dispensers 301 and 401 also form systems according to the present invention.

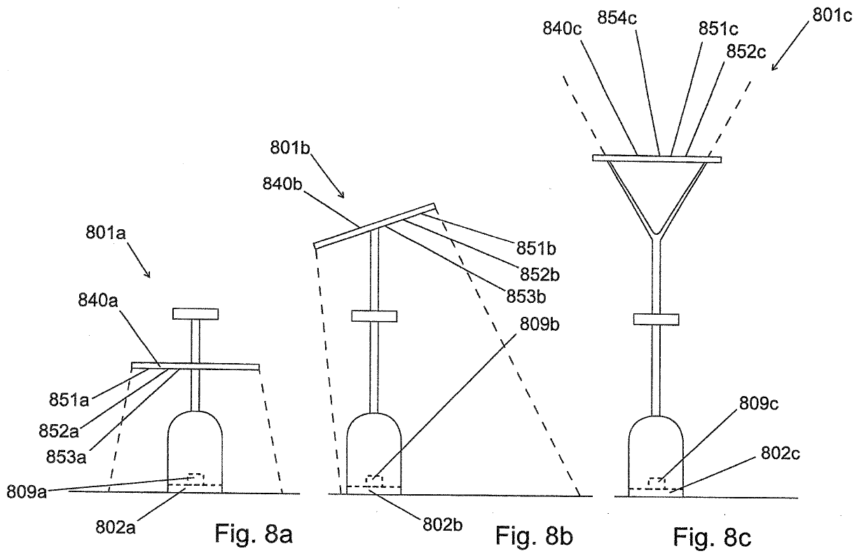

FIGS. 6 and 7 show two sectional representations of a fifth embodiment variant of a floor-standing energy dispenser 501, including an associated supply mechanism 580. The energy dispenser 501 is basically comparable in its embodiment to the energy dispenser 201 shown as a second embodiment in FIG. 2, and likewise comprises a platform 540. To maintain clarity, a cable assembly, which connects an energy storage device 509 to charging socket outlets 506, 507 and to a transmission mechanism 542 integrated in the platform 540 (see FIG. 7), has been omitted from the sectional representations. Likewise, the sectional representations do not show any connection mechanism via which a base plate 502 and a head 505 are connected. According to a first sub-variant, the energy dispenser 501 comprises such a connection mechanism. According to a second sub-variant, the energy dispenser is realized without such a connection mechanism.

Shown beneath the energy dispenser 501, in the same sectional view in each case, is the supply mechanism 580. Together with the supply mechanism 580, the energy dispenser 501 forms a system 590 according to the present invention.

Unlike the supply mechanism 180 shown in FIG. 1b, a wired energy supply can be provided for the energy dispenser 501 by the supply mechanism 580, when the energy dispenser 501 has been placed, by means of its base plate 502, onto a contact plate 581 of the supply mechanism 580, and in this case is received by positive engagement in such a manner that a casing 503 of the energy dispenser 501 is contacted, in a lower region, by a circumferential edge of the supply mechanism, and is thereby guided and aligned. For the purpose of wired energy transmission, the supply mechanism 580 comprises a connector 586, and the energy dispenser 501 comprises a mating connector 551, the connector 586 being arranged centrally on an upper side 581b of the contact plate 581, and the mating connector 551 being arranged centrally on an underside 502a of the contact plate 502. The connector 586 and the mating connector 551 in this case are realized as coaxial connectors, and are suitable for transmitting alternating current, such that the energy storage device 509 can be charged by the interposition of a charging device 518.

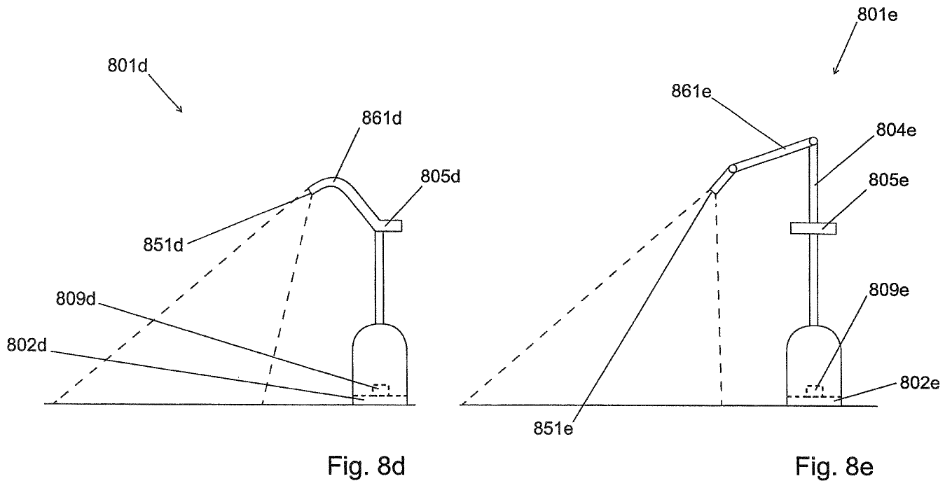

Shown in FIGS. 8a to 8e, in a schematic side view, are five variants of a sixth embodiment variant of a floor-standing energy dispenser 801a to 801e.

All variants of the energy dispenser 801a to 801e comprise a light source 851a to 851e, which is fed by an energy storage device 809a to 809e that in each case is integrated in the energy dispenser 801a to 801e.

In this case, the energy dispensers 801a to 801c are comparable in their design to the fifth embodiment variant, in that they each comprise a platform 840a, 840b, 840c.

The light sources 851a and 851b of the energy dispensers 801a and 801b, respectively, are each realized flat lamps 852a and 852b, respectively, that are each arranged on an underside 853a, 853b of the platform 840a, 840b that is opposite a base plate 802a, 802b.

The light source 851c of the energy dispenser 801c is realized as a flat lamp 852c that is arranged on an upper side 854c of the platform 840c that faces away from a base plate 802c.

In the case of the energy dispenser 801d, the light source 851d is realized on an extension 861d of a head 805d.

In the case of the energy dispenser 801e, the light source 851e is realized on an extension 861e of a neck 804e that extends beyond a head 805e.

In the case of all embodiment variants, the casing and the neck are embodied as rotationally symmetrical component parts.

### LIST OF REFERENCES

101 energy dispenser
H101 height of 101
102 base plate
D102 diameter of 102
102b upper side of 102
102d threaded nut of 102
103 casing
103a funnel inlet of 103
103b funnel outlet of 103
103c cavity of 103
104 tubular neck
104a tube inlet of 104
D104a diameter of 104
104b tube outlet of 104
104c interior of 104
105 head
105a head inlet of 105
105c interior of 105
105d threaded nut of 105
106 first charging socket outlet
107 second charging socket outlet
108 cable assembly
109 energy storage device 1
110a, 110b first end of 108
111a second end of 108
112 ring-type body
113 feed-through opening in 112
114 connection mechanism
115 threaded rod
116 grip element
117 receiving mechanism
118 charging device
119 set of power electronics
120 voltage transformer
121 inverter
180 supply mechanism
181 contact plate
182 transmission mechanism
190 system
S106, S107 connector
U base
x, x′ horizontal direction
201 energy dispenser
203 casing
204 neck
209 energy storage device
240 platform
241 tabletop
242 transmission mechanism
G mobile device
E receiving mechanism of G
301 energy dispenser 301
H301 height H301
304 neck 304
401 energy dispenser
403 casing
404 neck
405 head
501 energy dispenser
502 base plate
502a underside of 502
503 casing
505 head
506, 507 charging socket outlet
509 energy storage device
518 charging device
540 platform
542 transmission mechanism
551 mating connector
580 supply mechanism
581 contact plate
581b upper side of 581
586 connector
590 system
801a-801e energy dispenser
802a, 802b base plate
802c base plate
804e neck
805e head
805d head
809a-809e energy storage device
840a-840c platform
851a-851e light source
852a, 852b flat lamp
852c flat lamp
853a, 853b underside of 840a, 840b
854c upper side of 840c
861d extension of 805d
861e extension of 804e

1. A floor-standing energy dispenser comprising:
a base plate,
a funnel-type casing having a funnel inlet and a funnel outlet,
a tubular neck having a tube inlet and a tube outlet,
a head,
at least one charging socket outlet,
a cable assembly, and
an energy storage device for electrical energy,
the casing being connected by means of its funnel inlet to the base plate,
the casing transitioning by means of its funnel outlet into the inlet of the neck, and
the neck transitioning by means of its outlet into the head,
the at least one charging socket outlet being arranged in the head,
the at least one charging socket outlet being connected to a first end of the cable assembly,
the cable assembly being routed out of the head,
through an interior of the neck, into a cavity of the casing,
the energy storage device being arranged in the cavity of the casing, and
a second end of the cable assembly being connected to the energy storage device.

2. The floor-standing energy dispenser according to claim 1, wherein the energy storage device is realized as a ring-type body having a feed-through opening.

3. The floor-standing energy dispenser according to claim 1, wherein the energy dispenser additionally comprises a connection mechanism, the head being connected to the base plate, through the neck and the casing, by the connection mechanism, the connection mechanism being connected as a rigid connection mechanism, in particular as a rod, and preferably as a threaded rod, or as a flexible connection mechanism, in particular as a cord or a band, to the head and to the base plate in such a manner that, when the energy dispenser is being carried at the head that forms a grip element, neither the neck nor the casing has to transmit a tensile force resulting from the weight of the energy storage device.

4. The floor-standing energy dispenser according to claim 2, wherein the feed-through opening of the energy storage device is aligned centrally in relation to the base plate, and the energy storage device is supported, in particular flatly, on an upper side of the base plate, and the feed-through opening as the connection mechanism extending through it.

5. The floor-standing energy dispenser according to claim 1, wherein the base plate has a diameter that corresponds to at least 3 times, and preferably at least 4 times, a diameter of the neck.

6. The floor-standing energy dispenser according to claim 1, wherein the energy dispenser comprises at least one platform, the platform being arranged between the casing and the head, and in particular being arranged between the casing and the neck.

7. The floor-standing energy dispenser according to claim 6, wherein the platform comprises at least one transmission mechanism for wirelessly transmitting energy, the transmission mechanism being realized in such a manner that a mobile device, lying on the platform, that comprises a suitable receiving mechanism can be charged, the at least one transmission mechanism being connected to the energy storage device via the cable assembly.

8. The floor-standing energy dispenser according to claim 1, wherein the at least one charging socket outlet is arranged in the head in such a manner that, when the energy dispenser is upright, a connector of a device to be connected can be connected in the horizontal direction to the charging socket outlet and can be separated in the horizontal direction from the charging socket outlet.

9. The floor-standing energy dispenser according to claim 1, wherein the energy dispenser comprises a charging device, via which the energy storage device can be supplied and charged with electric current, the charging device being realized in such a manner that it can be supplied with electric current by means of a receiving mechanism that can be supplied wirelessly, and/or in a wired manner, by means of a mating connector.

10. The floor-standing energy dispenser according to claim 1, wherein,
the energy dispenser comprises a set of power electronics,
the set of power electronics comprising, in particular, a voltage transformer and an inverter,
the set of power electronics being connected, in particular, to the cable assembly, and being arranged, in particular, between the energy storage device and the at least one charging socket outlet, or being arranged, in particular, between the energy storage device and the at least one charging socket outlet and the platform.

11. The floor-standing energy dispenser according to claim 1, wherein the energy dispenser comprises at least one light source fed from the energy storage device, the light source being arranged, in particular as a flat lamp, on a surface of the energy dispenser that is opposite the base plate, in particular on an underside of a platform, or being arranged on a surface of the energy dispenser that faces away from the base plate, in particular on an upper side of a platform, or the light source being arranged on an extension of the head or on an extension of the neck.

12. The system comprising an energy dispenser and a supply mechanism, wherein the energy storage device is realized as a floor-standing energy dispenser according to claim 1, and a wired and/or wireless supply of energy for the energy dispenser is able to be provided by the supply mechanism, when the energy dispenser is placed with its base plate onto a contact plate of the supply mechanism.

13. The system according to claim 12, wherein the supply mechanism receives the base plate of the energy dispenser or the base plate and the casing of the energy dispenser by positive engagement.

14. The system according to claim 12, wherein, for the purpose of wirelessly transmitting energy, the supply mechanism comprises a transmission mechanism, and the energy dispenser comprises a receiving mechanism, the transmission mechanism being arranged, in particular, in the region of the contact plate of the supply mechanism, and the receiving mechanism being arranged, in particular, in the region of the base plate of the energy dispenser.

15. The system according to claim 12, wherein, for the purpose of wirelessly transmitting energy, the supply mechanism comprises a connector, and the energy dispenser comprises a mating connector, the connector being arranged, in particular, in the region of the contact plate of the supply mechanism, and in particular centrally on an upper side of the contact plate, the mating connector being arranged, in particular, in the region of the base plate of the energy dispenser, and in particular centrally on an underside of the contact plate, the connector and the mating connector being realized, in particular, as coaxial connectors, and preferably being realized as coaxial connectors designed for the transmission of alternating current.
